(19) United States
(12) Patent Application Publication
(10) Pub. No.: US 2009/0182669 A1
(43) Pub. Date: Jul. 16, 2009

(54) CARD DATA MANAGEMENT DEVICE AND METHOD THEREOF

(75) Inventors: Hongping Tian, Beijing (CN); Xizhe Li, Beijing (CN); Wei Xie, Beijing (CN); Yun Gu, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignee: Lenovo (Beijing) Limited, Beijing (CN)

(21) Appl. No.: 12/351,361

(22) Filed: Jan. 9, 2009

(30) Foreign Application Priority Data
Jan. 14, 2008 (CN) 200810056184.8

(51) Int. Cl. G06Q 99/00; H04L 9/00

(52) U.S. Cl. 705/50; 705/1

(57) ABSTRACT

The present invention discloses a card data management device comprising: a server interface module, for connecting the card data management device with a server and sending authorized data obtained from the server to a data management module; a data management module, for receiving the authorized data from the server via the server interface module and assigning the authorized data to at least one sub account; a binding relationship management module, for binding the at least one sub account with at least one card to create a binding relationship and downloading the authorized data in the at least one sub account to the corresponding card according to the binding relationship; a card management module connected with the binding relationship management module, for connecting and identifying the at least one card and sending the result of the card identification to the binding relationship management module. The invention also discloses a corresponding method that downloads the authorized data to the sub accounts or the cards bound with the sub accounts and is capable of identifying multiple cards, which saves resources and provides conveniences for users.

### BACKGROUND OF THE INVENTION

1. Field of Invention

The invention relates to data management, particularly to a card data management device and method thereof.

2. Description of Prior Art

Card data management plays an important role in the fields of finance, security, etc. The conventional data management systems impose strict constraints on system hardware devices primarily from the perspective of safeguarding data. For example, with an electronic bank and credit loader (also referred to as Quancun machine) illustrated in FIG. 1, the system mainly comprises a bank host computer, a bank front-end machine, various credit loaders and their corresponding cards. In the so-called credit loading system, a credit loader is connected with the bank host computer via the bank front-end machine in the case of a small amount of electronic payment by a user (e.g. utility fee, campus card). Credit loaders are prohibited from any movement or change (e.g. being bound with certain telephone numbers) out of security concern.

The user inserts his or her card into a corresponding credit loader and enters bank card information, card password, and the amount of money to be loaded. The credit loader encrypts and packs such critical information, and then sends it to the bank front-end machine. Data is unpacked and decrypted by the bank front-end machine. If the card is checked as valid, transaction processing is performed to subtract the loaded amount from the account balance of the corresponding card so that the account transfer is furnished. The bank transfers the processing result to the bank front-end machine, which then encrypts and packs the content and sends a processing request to the credit loader. The credit loader processes the processing request sent from the bank front-end machine, obtains transaction code information from the processing request by means of unpacking and decrypting. At the same time, the credit loader adds the loaded amount of money to the balance of the corresponding card according to card information and the loaded amount so as to complete account transfer from the bank card to the corresponding card. However, disadvantages exist in these conventional solutions in at least the following aspects:

1) The credit loader has to be fixed (being bound with a certain telephone, the same processing mode as POS machine) and attended by an operator. As a result, the user has to go to a certain place for credit loading. Credit loading service is not available at any time since the credit loader must be attended by an operator.

2) Each type of credit loader corresponds to only one payment card. If the user has payment cards, such as a campus card, a utility fee card, a cable TV toll card, a public transport card, it is inconvenient for the user to go to different credit loaders to recharge these cards.

3) The user can not make a unified allocation of his accounts. Refunding and recharging of cards depends upon the credit loaders operated by staff. This results in non-real-time refund and waste of time.

### SUMMARY OF THE INVENTION

In view of the above problems, one aspect of the present invention provides a card data management device which can identify multiple types of cards simultaneously and thus conserve system resources.

Another aspect of the present invention provides a card data management method which can identify multiple types of data cards and is easy to operate.

To achieve the above objects, the solutions of the present invention are implemented as follows.

A card data management device, the device comprises:

a server interface module, for connecting the card data management device with a server and sending authorized data obtained from the server to a data management module;

a data management module, for receiving the authorized data from the server via the server interface module and assigning the authorized data to at least one sub account;

a binding relationship management module, for binding the at least one sub account with at least one card to create a binding relationship and downloading the authorized data in the at least one sub account to the corresponding card according to the binding relationship;

a card management module connected with the binding relationship management module, for connecting and identifying the at least one card and sending the result of the card identification to the binding relationship management module.

Preferably, in the device, the card management module comprises a card interface module for connecting various cards and a card identification module for identifying the types of the cards according to information in the cards;

the data management module comprises a key module for connecting the server interface module and the binding relationship management module and encrypting and/or decrypting uploaded or downloaded data; and

the connection between the card interface module and data cards is realized by USB, short-range wireless, infrared, serial port, or any combination thereof.

A card data management method, the method comprises steps of:

receiving authorized data from a server and assigning the authorized data to at least one sub account;

binding the at least one sub account with at least one card to create a binding relationship;

downloading the authorized data in the at least one sub account to the corresponding card according to the binding relationship.

Preferably, the method further comprises a step of identifying the card information of the at least one card and using the card information to create the binding relationship;

before the step of receiving authorized data from a server and assigning the authorized data to at least one sub account, the method further comprises a step of registering to the server the data management device and the at least one card to obtain authentication of the server, the registration information comprising at least identity card number, password and biometric data;.

The method may further comprises a step of reassigning the authorized data in the at least one sub account;

In another aspect of the invention, the method further comprises a step of uploading to the server the information that is downloaded into the at least one card.

The solution of the present invention employs a card identification module to identify multiple types of cards simultaneously and can be applied to various card data management fields. It overcomes the drawback in the conventional card management device that each type of card corresponds to only a single card management device. Moreover, authorized data is stored and downloaded, i.e. authorized data in different sub accounts is re-deposited, which saves server resources and facilitates users. The card data management device can be installed in a computer and directly connected with an electronic bank, an access card system and the like without being manually attended, with improved ease of use.

### BRIEF DESCRIPTION OF THE DRAWINGS

FIG. 1 is a schematic diagram of managing the card data management by an conventional credit loading system;

FIG. 2 is a schematic diagram of the first embodiment of device of the present invention;

FIG. 3 is a schematic diagram of the second embodiment of device of the present invention.

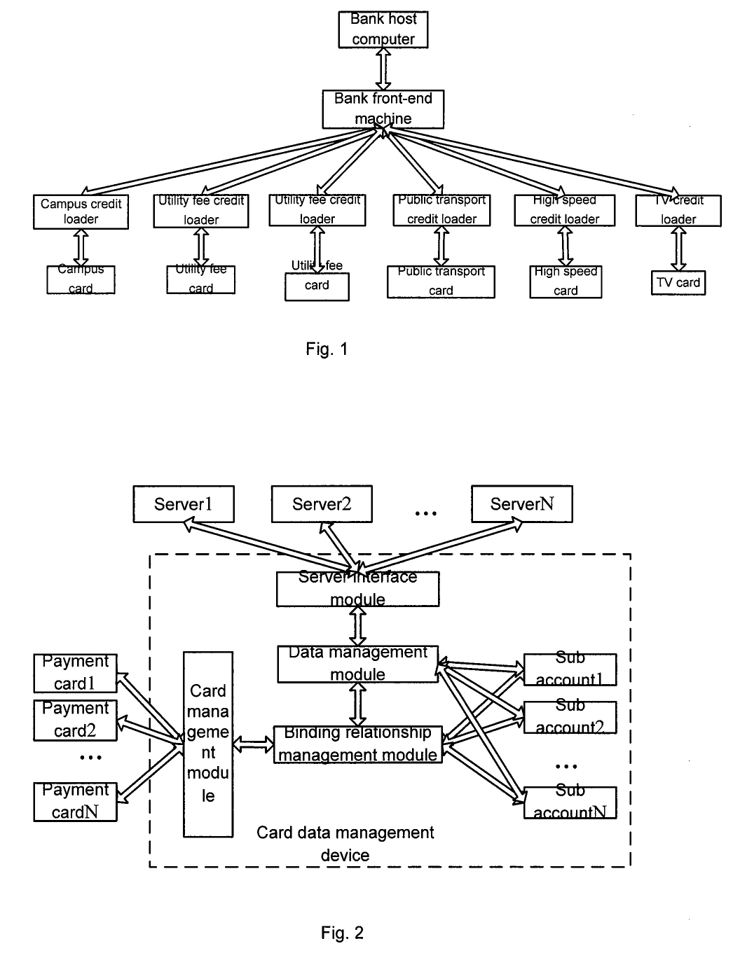

### DETAILED DESCRIPTION OF PREFERRED EMBODIMENTS

The data management module of the card data management device according to an embodiment of the present invention can fulfill reassignment of authorized data, identify different types of cards and realize a unified management. This reduces repeated construction of terminal card management devices and provides conveniences for users.

### First Embodiment of Device

The card data management device will be explained in details in combination with the first embodiment of device of the present invention.

As illustrated in FIG. 2, the payment card management device comprises a server interface module, a data management module, a binding relationship management module and a card management module. The server interface module, the data management module, the binding relationship management module are connected in order, with the card management module being connected to the binding relationship management module.

The server interface module is configured for connecting the card data management device with a server of each of respective electronic banks and sending to the data management module authorized data obtained from the servers of these electronic banks. The authorized data is the amount of money drawn from bank accounts by users.

The data management module is configured for receiving from the servers of the respective electronic banks the amount of money drawn from the bank accounts via the server interface module, and assigning the amount of money drawn from the bank accounts to sub accounts, with the number of the sub accounts being at least one.

The binding relationship management module is configured for binding various payment cards with the sub accounts to create a binding relationship and loading the amount of money in the sub accounts into the corresponding payment cards, respectively, according to the binding relationship.

The card management module is configured for connecting and identifying the various payment cards. The card management module comprises a card interface module for connecting the various payment cards and a card identification module. The connection between the card interface module and the payment cards is USB interface, short range wireless, serial port, etc. or any combination thereof. The card identification module is used to read payment card information which includes card type, account balance, users etc., and to identify the type of a payment card according to the information in the payment card.

The payment card management device is mounted on a personal computer and manages each of various payment cards by connecting to a server of an electronic bank through network. Data in the card data management device can also be regularly and periodically uploaded to the server of the electronic bank, so that the electronic bank can easily check items of the account. When the data is uploaded, encryption algorithms may also be employed to safeguard the data.

### Second Embodiment of Device

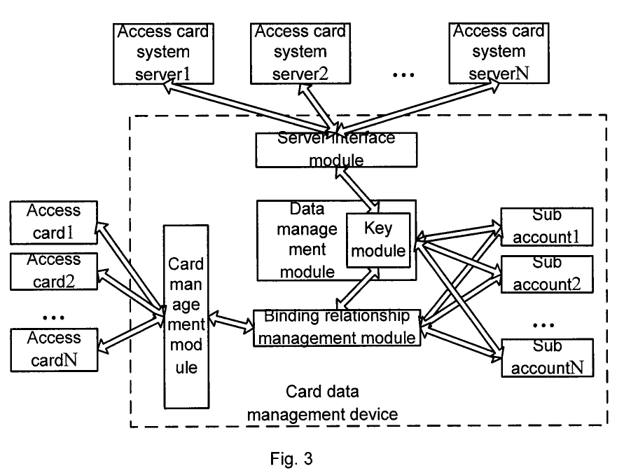

The second embodiment of device of the present invention is an access card management device, as illustrated in FIG. 3. For locations with strict access permission, a user needs different access cards to enter into the respective places. Thus, he or she needs to obtain access time authorized by the respective access system. This embodiment is different from the first embodiment of device in that the device has modules configured as follows.

A server interface module is configured for connecting the card data management device with servers of respective access card systems and sending to a data management module authorized data obtained from the servers of the respective entrance guard systems. The authorized data is the authorized access time fetched from the access card systems by users.

The data management module is configured for receiving the access time fetched from the servers of the respective access systems via the server interface module, and assigning the access time to sub accounts, the number of the sub accounts being at least one. The data management module further comprises a key module that connects the server interface module with the binding relationship management module and that is used to encrypt and decrypt uploaded or downloaded data of access time.

A binding relationship management module is configured for binding respective access cards with the sub accounts to create a binding relationship and loading the access time in the sub accounts into the corresponding access cards according to the binding relationship.

A card management module is configured for connecting and identifying each of the respective access cards. The card management module comprises a card interface module employing infrared interfaces to connect to the respective access cards and a card identification module for reading access card information which includes card type, access time etc. The card identification module identifies each of the respective access cards based on the access card information to prevent impersonation.

### First Embodiment of Method

For the first embodiment of device, when used to manage payment cards, the following steps are carried out.

First, the card data management device is registered to a server to obtain authorization and authentication from the server. The registration can be realized by using identity card number, password, biometric data, etc. The card data management device can be registered to more than one server to obtain authorization from each of the servers, so that the payment cards are easily to be recharged. Before different payment cards (e.g. campus cards, utility fee cards, etc.) are actually used, the information on each payment card is required to be registered to the server of a respective electronic bank via the card data management device.

After being authorized by the server, the card data management device can obtain authorized data from the server. The authorized data is the amount of money deposited in the user's account of the electronic bank. After the amount of money from the server is obtained, the card data management device can assign the money to respective sub accounts according to the user's requirement, or can also directly save it in the data management module for further use instead of assigning it.

When a payment card is recharged, the information on the payment card is sent to the card identification module by the card interface module of the card management module. The card identification module identifies the type of the payment card according to this information and sends the information on the card type, etc. to the binding relationship management module.

After receiving the information on the card type, etc., the binding relationship management module binds the payment card with a sub account according to the user's requirement. When the payment card is bound, the user can set binding period, unbinding conditions, constraints on times of usage, etc.

According to the binding relationship, the user can recharge the payment card from the corresponding sub account.

The binding relationship can be changed according to the user's requirement and enable account transfer in different sub accounts. For example, payment card 1 is bound with sub account 1 and to be recharged with RMB 100 yuan. At this time, payment card 1 can only be recharged with 50 yuan from sub account 1. The binding relationship can then be changed by binding payment card 1 with sub account 2. Payment card 1 can be recharged with 50 yuan from sub account 2, and the user's requirement can be met. As another example, when there is no money in any of the sub accounts, and the data management module stores 100 yuan. The 100 RMB can be downloaded from the data management module to sub account 1 and then recharged to payment card 1.

Moreover, in order to prevent from being stolen, when the card is used, the information on the card type, etc. can also be sent together with the information on the card data management device via the data management module to the server side The server examines the information, confirms that the card and the device are both registered and then allows further use.

### Second Embodiment of Method

For the second embodiment of device, when employed to manage an access card, the following steps are carried out.

The card data management device is registered to each of respective access card systems to obtain authorized access time. The type of authorized access time may be either permanent or temporary, for example, 5:00 to 24:00 every day for Area A, 8:00 to 10:00 on Sunday for Area B, etc.

Various access cards are registered to the access card systems to obtain authentication of the systems. The access card systems, when downloading access time, employ an encryption algorithm to encrypt the data in order to ensure security.

The data of authorized access time is decrypted by the key module, and the authorized access time is then assigned to respective sub accounts by the data management module.

Each of the user's access cards is bound with a sub account. The access time is distributed from the sub account to the corresponding access card.

When the data of access time data is distributed, the data is encrypted by the key module of the data management module and uploaded to the corresponding access card system for further data examination.

The foregoing is only preferred embodiments of the present invention and not intended to limit the scope of the invention.

What is claimed is:

1. A card data management device, characterized in that the device comprises:
a server interface module, for connecting the card data management device with a server and sending authorized data obtained from the server to a data management module;
a data management module, for receiving the authorized data from the server via the server interface module and assigning the authorized data to at least one sub account;
a binding relationship management module, for binding the at least one sub account with at least one card to create a binding relationship and downloading the authorized data in the at least one sub account to the corresponding card according to the binding relationship;
a card management module connected with the binding relationship management module, for connecting and identifying the at least one card and sending the result of the card identification to the binding relationship management module.

2. The card data management device according to claim 1, characterized in that the card management module comprises a card interface module for connecting various cards and a card identification module for identifying the types of the cards according to information in the cards.

3. The card data management device according to claim 1, characterized in that the data management module comprises a key module for connecting the server interface module and the binding relationship management module and encrypting and/or decrypting uploaded or downloaded data.

4. The card data management device according to claim 2, characterized in that the connection between the card interface module and data cards is realized by USB, short-range wireless, infrared, serial port, or any combination thereof.

5. A card data management method, characterized in that the method comprises steps of:
receiving authorized data from a server and assigning the authorized data to at least one sub account;
binding the at least one sub account with at least one card to create a binding relationship;
downloading the authorized data in the at least one sub account to the corresponding card according to the binding relationship.

6. The card data management method according to claim 5, characterized in that the method further comprises a step of identifying the card information of the at least one card and using the card information to create the binding relationship.

7. The card data management method according to claim 6, characterized in that before the step of receiving authorized data from a server and assigning the authorized data to at least one sub account, the method further comprises a step of registering to the server the data management device and the at least one card to obtain authentication of the server, the registration information comprising at least identity card number, password and biometric data.

8. The card data management method according to claim 7, characterized in that the method further comprises a step of reassigning the authorized data in the at least one sub account.

9. The card data management method according to claim 8, characterized in that the method further comprises a step of uploading to the server the information that is downloaded into the at least one card.
